(19) United States
(12) Patent Application Publication
(10) Pub. No.: US 2020/0031144 A1
(43) Pub. Date: Jan. 30, 2020

(54) PRINTING DEVICE

(71) Applicant: SEIKO EPSON CORPORATION, Tokyo (JP)

(72) Inventors: Masakazu ISHIHARA, Matsumoto-shi (JP); Hiroki KOYAMA, Shiojiri-Shi (JP)

(21) Appl. No.: 16/519,367

(22) Filed: Jul. 23, 2019

(30) Foreign Application Priority Data
Jul. 27, 2018 (JP) 2018-141450

(51) Int. Cl. B41J 11/00

(52) U.S. Cl. CPC B41J 11/006; B41J 11/0045

(57) ABSTRACT

A printing device includes a print section. A main unit, which has a supply port via which the medium is to be inserted on its upper surface. The medium inserted via the supply port is to be guided to the print section along an upper feeding route. This upper feeding route has a first curve at its midway point. Positioned below the main unit is a medium storage section that accommodates a medium. The medium accommodated in the medium storage section is to be guided to the print section along a lower feeding route. This lower feeding route has a second curve at its midway point, where the medium is to be turned around. The main unit includes: a first cover that allows the upper feeding route to be exposed; and a second cover that allows the lower feeding route to be exposed.

The present application is based on, and claims priority from JP Application Serial Number 2018-141450, filed Jul., 27, 2018, the disclosure of which is hereby incorporated by reference herein in its entirety.

### BACKGROUND

### 1. Technical Field

The present disclosure relates to printing devices such as ink jet printers.

### 2. Related Art

JP-A-2014-218380 discloses an image recording device as an example of printing devices. This image recording device includes: a first transport route and a second transport route along which sheets or other media are to be transported; and a jam processing cover that closes these first and second transport routes in an openable manner. If a sheet is stuck on the first or second transport route, the user needs to open the jam processing cover and remove it.

Whichever a sheet is stuck on the first or second transport route in the above image recording device, the user only has to open the jam processing cover and remove the sheet. However, the user may have trouble removing a stuck sheet, depending on its location.

### SUMMARY

According to an aspect of the present disclosure, a printing device includes a print section that performs a printing operation on a medium. This print section is accommodated in a main unit, which has a supply port via which the medium is to be inserted on its upper surface. The medium inserted via the supply port is to be guided to the print section along an upper feeding route. This upper feeding route has a first curve at its midway point, where the medium is to be turned around. Positioned below the main unit is a medium storage section that accommodates a medium. The medium accommodated in the medium storage section is to be guided to the print section along a lower feeding route. This lower feeding route has a second curve at its midway point, where the medium is to be turned around. The main unit includes: a first cover that allows the upper feeding route to be exposed; and a second cover that allows the lower feeding route to be exposed.

### BRIEF DESCRIPTION OF THE DRAWINGS

FIG. 1 is a perspective view of a printing device according to an embodiment of the present disclosure.

FIG. 2 is a cross-sectional side view of the printing device.

FIG. 3 is a perspective view of the printing device with the first and third covers opened and with the second cover detached.

FIG. 4 is a cross-sectional side view of the printing device with the first and third covers opened and with the second cover detached.

FIG. 5 is a table that lists operational instructions to be notified when a medium that has been inserted via the supply port is stuck in the printing device.

### DESCRIPTION OF EXEMPLARY EMBODIMENTS

A printing device according to an embodiment of the present disclosure will be described below with reference to the accompanying drawings. The printing device may be an ink jet printer that prints letters, pictures, and images on media by discharging liquids onto the media. As an example, the media may be paper sheets, and the liquids may be inks.

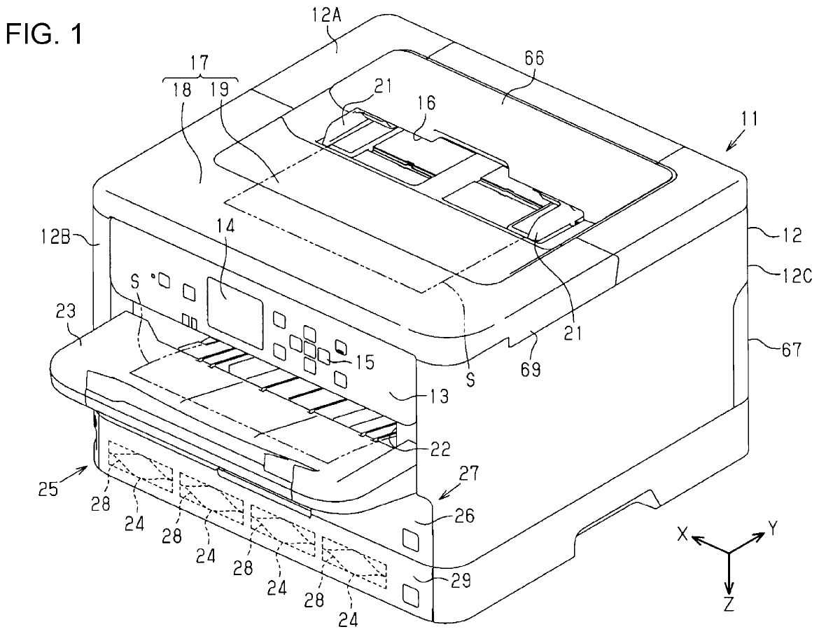

As illustrated in FIG. 1, the printing device 11 includes a main unit 12 that occupies a predetermined space at an installation site. In FIGS. 1 to 4, the printing device 11 is installed on the horizontal plane; the Z-axis is parallel to the direction of gravitational force; and the X- and Y-axes are parallel to a plane intersecting the Z-axis. In this case, the X-, Y-, and Z-axes intersect at right angles, and each of the X- and Y-axes extends in parallel with the horizontal plane. A depth direction of the main unit 12 is parallel to the Y-axis, and a width direction of the main unit 12 is parallel to the X-axis. In this embodiment, the X-axis is a coordinate axis indicating the width of the printing device 11; the Y-axis is a coordinate axis indicating the depth of the printing device 11; and the Z-axis is a coordinate axis indicating the height of the printing device 11. Hereinafter, in some cases, a direction on the X-axis is referred to as a width direction X; a direction on the Y-axis is referred to as a depth direction Y; and a direction on the Z-axis is referred to as the vertical direction Z.

The main unit 12 includes: an upper surface 12A, a front surface 12B, and a rear surface 12C. The front surface 12B is one side of the printing device 11 which has a predetermined height and width and is mainly used for the user to operate the printing device 11. The direction from the front surface 12B to the rear surface 12C in the main unit 12 corresponds to the depth direction Y.

The printing device 11 further includes an operating section 13 disposed in a portion of the front surface 12B of the main unit 12. The operating section 13 allows for the operation of the printing device 11. The operating section 13 includes: a display screen 14 on which various information appears; and a plurality of buttons 15 to be used for the user to enter various instructions in printing device 11.

The upper surface 12A of the main unit 12 is provided with a supply port 16 via which a medium S is to be inserted into the main unit 12. In this embodiment, the supply port 16 is positioned closer to the rear surface 12C than the front surface 12B. Provided on the upper surface 12A between the front surface 12B and the supply port 16 is a placement surface 17 on which a medium S is to be placed. A portion of the placement surface 17 gradually slopes down toward the supply port 16. Thus, when placed on the placement surface 17, a medium S is smoothly guided to the supply port 16.

In this embodiment, the placement surface 17 includes a first placement surface 18 and a second placement surface 19. The first placement surface 18 is parallel to the surface on which the printing device 11 is installed, and the second placement surface 19 is angled with respect to the first placement surface 18 and continues to the supply port 16. When a medium S is placed on the placement surface 17, a portion of the medium S is inserted into the main unit 12 via the supply port 16. Then, the entire medium S is inserted into the main unit 12.

The printing device 11 may further include a pair of edge guides 21 along which the medium S placed on the placement surface 17 is to be guided to the supply port 16. In this embodiment, the edge guides 21 may be formed on the second placement surface 19 so as to be movable in the width direction X and the opposite direction. By bringing the edge guides 21 into contact with the side edges of the medium S placed on the placement surface 17, an angle of the medium S may be corrected.

The main unit 12 may further include an ejection port 22 from which the medium S is to be ejected. In this embodiment, the ejection port 22 may be formed on the front surface 12B of the main unit 12 below the operating section 13. Via the ejection port 22, the medium S on which letters, pictures, or images have been printed may be ejected from the main unit 12 to the outside.

The printing device 11 may further include an ejection tray 23 on which the media S are to be placed. In this embodiment, the ejection tray 23 may protrude forward from the front surface 12B. After ejected via the ejection port 22, the medium S may be placed on the ejection tray 23.

The printing device 11 may include a first attachment 25, a medium storage section 26, and a second attachment 27. The first attachment 25 may accommodate one or more containers 24, and the second attachment 27 may accommodate the medium storage section 26. In this embodiment, both the first attachment 25 and the second attachment 27 may be provided, in the vertical direction Z, in a lower portion of the main unit 12 below the ejection tray 23. The first attachment 25 may be positioned below the second attachment 27.

In this embodiment, the first attachment 25 accommodates four containers 24, which may be detachably attached to the first attachment 25. Each of the containers 24 accommodates a liquid storage section 28 containing a liquid. The liquid storage sections 28 may be detachably attached to the corresponding containers 24. The liquids contained in the respective liquid storage sections 28 may be used for the printing device 11 to perform a printing operation on the medium S.

The liquids contained in the respective liquid storage sections 28 may be of different types. Examples of the liquids include black, cyan, magenta, and yellow inks. The containers 24 may be attachable to the first attachment 25 without accommodating the respective liquid storage sections 28. The liquid storage sections 28 may be directly attachable to the first attachment 25 without accommodating the respective containers 24. Each liquid storage section 28 may be an ink pack, for example.

In this embodiment, the first attachment 25 is covered with a front panel 29, which forms a portion of the front surface 12B of the main unit 12. The front panel 29 is pivotable around its lower edge. When the front panel 29 is opened, the first attachment 25 is exposed to the outside, in which case the containers 24 can be detached from the liquid storage sections 28.

In the printing device 11, the medium storage section 26, which is disposed in the lower portion of the main unit 12, accommodates media S. As an example, the medium storage section 26 may accommodate a stack of media S. The medium storage section 26 is detachable from the second attachment 27. The medium storage section 26 may be a cassette detachably attached to the main unit 12. When being attached to the main unit 12, the medium storage section 26 forms a portion of the front surface 12B of the main unit 12.

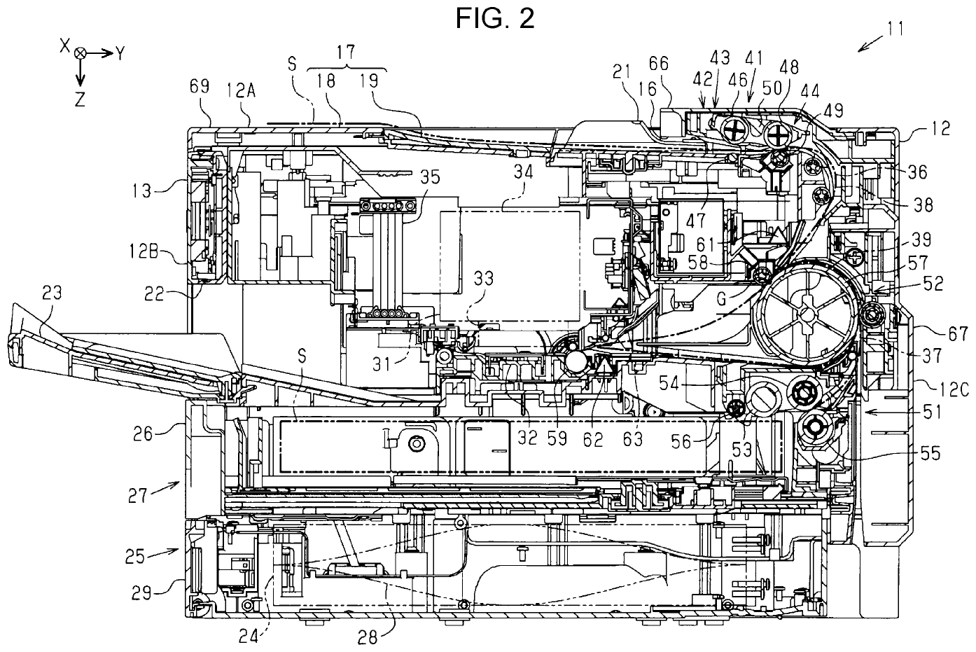

The printing device 11 may further include a central processing unit (CPU) and a memory, for example. The printing device 11 performs various processing operations by causing the CPU to execute programs stored in the memory. As illustrated in FIG. 2, the printing device 11 further includes: a print section 31 that performs the printing operation on media S; and a support section 32 that supports the media S. Both of the print section 31 and the support section 32 are accommodated in the main unit 12. In this embodiment, both the print section 31 and the support section 32 are positioned above the medium storage section 26 attached to the second attachment 27. The support section 32, which is positioned opposite the print section 31 in the vertical direction Z, supports the medium S from the bottom when the print section 31 performs the printing operation on a medium S.

The print section 31 performs the printing operation on the media S with the liquids. In this embodiment, the print section 31 includes: heads 33 that discharge the liquids onto the medium S; and a carriage 34 in which the heads 33 are mounted. The carriage 34 is movable in the width direction X and the opposite direction. In this embodiment, the printing device 11 may be a serial printer in which the heads 33 move together with the carriage 34. Alternatively, the printing device 11 may be a line printer in which each heads 33 elongates in the width direction X.

The printing device 11 may include a plurality of liquid tubes 35 via which the print section 31 is coupled to the respective liquid storage sections 28 attached to the first attachment 25. The liquid tubes 35 allow the liquids to flow from the liquid storage sections 28 attached to the first attachment 25 to the print section 31. The print section 31 performs the printing operation on the media S with the liquids supplied from the liquid storage sections 28 through the liquid tubes 35.

The printing device 11 further includes an upper feeding route 36 along which the medium S inserted via the supply port 16 are to be guided to the print section 31. In addition, the printing device 11 further includes a lower feeding route 37 along which the media S accommodated in the medium storage section 26 are to be guided to the print section 31. In this embodiment, the upper feeding route 36 is joined to the lower feeding route 37. In this embodiment, the location at which the upper feeding route 36 is joined to the lower feeding route 37 is referred to below as the merging point G. In this case, the downstream end of the upper feeding route 36 is positioned at the merging point G. When inserted via the supply port 16, the medium S is transported along the upper feeding route 36 and the lower feeding route 37 in this order and then reaches the print section 31. However, the upper feeding route 36 does not necessarily have to be joined to the lower feeding route 37. As an alternative example, the upper feeding route 36 and the lower feeding route 37 may extend to the print section 31 separately from each other.

In this embodiment, the medium S that has been inserted via the supply port 16 is transported to the print section 31 along both the upper feeding route 36 and the lower feeding route 37. The media S accommodated in the medium storage section 26 are transported to the print section 31 along the lower feeding route 37 alone.

The upper feeding route 36 has a first curve 38 at its midway point, where the medium S is to be turned around. The first curve 38 is a portion of the upper feeding route 36 which is formed to turn around the medium S. In this embodiment, the upper feeding route 36 extends from the supply port 16 to the merging point G. More specifically, the upper feeding route 36 with the first curve 38 extends inside the main unit 12 from a midway point between the supply port 16 and the rear surface 12C to the merging point G. When transferred along the upper feeding route 36, the medium S is turned around at the first curve 38.

The lower feeding route 37 has a second curve 39 at its midway point, where the medium S is to be turned around. The second curve 39 is a portion of the lower feeding route 37 which is formed to turn around the medium S. In this embodiment, the lower feeding route 37 extends from the second attachment 27 to the print section 31. More specifically, the lower feeding route 37 with the second curve 39 extends inside the main unit 12 from a midway point between the medium storage section 26 and the rear surface 12C to the merging point G. The lower feeding route 37 is joined to the upper feeding route 36 at the merging point G and further extends to both the print section 31 and the support section 32.

The printing device 11 may further include an upper feeder 41 that feeds the medium S along the upper feeding route 36. As an example, the upper feeder 41 may include roller pairs 42. The roller pairs 42 may rotate while pinching the medium S, thereby feeding the medium S. The roller pairs 42 may be positioned on the upper feeding route 36 between the supply port 16 and the first curve 38, namely, may be positioned upstream of the first curve 38. In this embodiment, the roller pairs 42 in the printing device 11 include a first roller pair 43 and a second roller pair 44.

The first roller pair 43 is positioned on the upper feeding route 36 between the supply port 16 and the second roller pair 44, namely, positioned upstream of the second roller pair 44. In other words, the first roller pair 43 is positioned, in the depth direction Y, between the front surface 12B of the main unit 12 and the second roller pair 44.

The first roller pair 43 includes a first roller 46 and a second roller 47. The first roller 46 makes contact with the medium S from the top, whereas the second roller 47 makes contact with the medium S from the bottom. As an example, each of the first roller 46 and the second roller 47 may be driven and rotated by a motor.

The outer circumferential surface of the second roller 47 which makes contact with the medium S has a larger coefficient of friction than that of the first roller 46. In addition, the second roller 47 rotates at a slightly lower speed than that of the first roller 46. Because of these differences in coefficient of friction and rotation speed between the first roller 46 and the second roller 47, the first roller pair 43 can suppress multi-feeding of the medium S. As a result, even if a plurality of media S are pinched between the first roller 46 and the second roller 47, the first roller pair 43 can separate the medium S from one another. For example, if a plurality of media S are pinched, the first roller pair 43 may feed only the outermost one. The expression “multi-feeding of media S” herein refers to the event in which a plurality of media S are fed together while stacked.

The second roller 47 may be driven and rotated by the rotation of the first roller 46. In this case, the second roller 47 may have a rotational resistance that is set to be high enough to suppress the multi-feeding of the media S.

The second roller 47 may be rotatable in a direction that is the reverse of a transport direction of the medium S. As an example, the second roller 47 may be driven by a motor so as to rotate counterclockwise in the page of FIG. 2. In this case, the second roller 47 may be provided with a torque limiter that breaks the connection between the second roller 47 and the motor under a predetermined rotational load. After the torque limiter has broken the connection, the second roller 47 is driven and rotated by the rotation of the first roller 46. More specifically, after the torque limiter has broken the connection, the second roller 47 rotates clockwise in the page of FIG. 2. With this configuration, when the first roller pair 43 pinches a single medium S, the second roller 47 is driven and rotated by the rotation of the first roller 46. However, if the first roller pair 43 pinches a plurality of media S, the second roller 47 rotates in the direction that is the reverse of the transport direction of the media S. In this way, the multi-feeding of the media S is suppressed.

The second roller pair 44 includes a third roller 48 and a fourth roller 49. The third roller 48 makes contact with the medium S from the top, whereas the fourth roller 49 makes contact with the medium S from the bottom. The second roller pair 44 feeds the medium S at substantially the same speed as that of the first roller pair 43. As an example, the third roller 48 may be driven and rotated by a motor. The fourth roller 49 may be driven and rotated by the rotation of the third roller 48.

In this embodiment, both of the first roller 46 and the third roller 48 may be supported by a support section 50 so as to be rotatable relative to the support section 50. The support section 50 is displaceable between a feeding location and a non-feeding location. Further, when the medium S is fed from the placement surface 17, the support section 50 is displaced to the feeding location. When the medium S is not fed from the placement surface 17, the support section 50 is displaced to the non-feeding location. In FIG. 2, the support section 50 is disposed at the non-feeding location. When the support section 50 is disposed at the non-feeding location, the first roller 46 cannot make contact with the second roller 47. When the support section 50 is disposed at the feeding location, the first roller 46 can make contact with the second roller 47. When fed from the placement surface 17, the medium S is pinched between the first roller 46 and the second roller 47. When no media S are placed on the placement surface 17, the first roller 46 and the second roller 47 are in contact with each other. The third roller 48 is in contact with the fourth roller 49 independently of the position of the support section 50.

The support section 50 is normally positioned at the non-feeding location. When the printing device 11 performs the printing operation on the medium S fed from the placement surface 17, the support section 50 is displaced to the feeding location. After the printing device 11 has finished the printing operation on the medium S, the support section 50 is displaced to the non-feeding location.

The printing device 11 may further include a supply section 51 and a lower feeder 52. The supply section 51 may transport the medium S from the medium storage section 26 to the lower feeder 52. The lower feeder 52 may receive the medium S from the medium storage section 26 and transport the medium S along the lower feeding route 37. The supply section 51 transports, along the lower feeding route 37, the media S from the medium storage section 26 attached to the second attachment 27. The lower feeder 52 transports the medium S transported from the supply section 51.

The supply section 51 includes a pickup roller 53, a separate roller 54, a retard roller 55, and a press roller 56. The pickup roller 53 rotates while being in contact with the upper surface of the medium S in the medium storage section 26 attached to the second attachment 27, thereby feeding the medium S from the medium storage section 26. Both the separate roller 54 and the retard roller 55 rotate while pinching the medium S that the pickup roller 53 has fed from the medium storage section 26, thereby feeding the medium S along the lower feeding route 37.

The pickup roller 53 is positioned above the side of the medium storage section 26 attached to the second attachment 27 which is closer to the rear surface 12C of the main unit 12. The pickup roller 53 rotates counterclockwise in the page of FIG. 2, or in the forward direction, thereby feeding the medium S from the medium storage section 26. Both the separate roller 54 and the retard roller 55, which face each other, are positioned between the pickup roller 53 and the rear surface 12C of the main unit 12. The retard roller 55 is positioned below the separate roller 54.

The retard roller 55 is driven and rotated by the rotation of the separate roller 54. The outer circumferential surface of the retard roller 55 which makes contact with the medium S has a larger coefficient of friction than that of the separate roller 54. Because of this difference in coefficient of friction, both the retard roller 55 and the separate roller 54 separate the media S from one another if pinching a plurality of media S fed from the medium storage section 26. In this way, both the retard roller 55 and the separate roller 54 suppress the multi-feeding of the media S.

The retard roller 55 may rotate at a slightly lower speed than that of the separate roller 54. In addition, the retard roller 55 may be rotatable in a direction that is the reverse of the transport direction of the media S. In this case, the retard roller 55 may be provided with a torque limiter. This configuration can also suppress the multi-feeding of the media S.

The press roller 56 is positioned between the pickup roller 53 and the front surface 12B of the main unit 12. The press roller 56 presses, from the top, the media S in the medium storage section 26 attached to the second attachment 27.

The lower feeder 52 includes a plurality of rollers arranged along the lower feeding route 37. In this embodiment, the lower feeder 52 includes a first feeding roller 57, a second feeding roller 58, and a third feeding roller 59. Further, the first feeding roller 57, the second feeding roller 58, and the third feeding roller 59 are arranged in this order from the upstream end of the lower feeding route 37. In addition to the first feeding roller 57, the second feeding roller 58, and the third feeding roller 59, the lower feeder 52 may further include some other rollers.

The first feeding roller 57 has an outer circumferential surface conforming to the second curve 39. The first feeding roller 57 feeds the medium S while bending the medium S at the second curve 39. When transported to the second curve 39 along the lower feeding route 37, the medium S is bent along the outer circumferential surface of the first feeding roller 57. In this embodiment, the second curve 39 is a portion of the lower feeding route 37 which is formed to bend the medium S in conformity with the first feeding roller 57. In this embodiment, the first feeding roller 57 is positioned directly above the separate roller 54. As an example, the first feeding roller 57 may be driven and rotated by a motor.

Both the first feeding roller 57 and the second feeding roller 58 pinch the medium S transported along the upper feeding route 36 or the lower feeding route 37. When both the first feeding roller 57 and the second feeding roller 58 rotate with the medium S therebetween, thereby feeding the medium S along the lower feeding route 37. The second feeding roller 58 is positioned so as to make contact the medium S at or downstream of the merging point G where the upper feeding route 36 is joined to the lower feeding route 37. In this case, both the first feeding roller 57 and the second feeding roller 58 feed the medium S transported from the medium storage section 26 or inserted via the supply port 16. In this embodiment, the second feeding roller 58 is positioned so as to make contact with the medium S at the merging point G. As an example, the second feeding roller 58 may be driven and rotated by the rotation of the first feeding roller 57.

The third feeding roller 59 is positioned on the lower feeding route 37 between the first feeding roller 57 and the print section 31. In other words, the third feeding roller 59 is positioned on the lower feeding route 37 and downstream of the first feeding roller 57. In this embodiment, the third feeding roller 59 is positioned adjacent to the support section 32. The third feeding roller 59 feeds the medium S fed by both the first feeding roller 57 and the second feeding roller 58 along the lower feeding route 37.

In this embodiment, the first curve 38 corresponds to a portion of the upper feeding route 36 between a location at which the medium S is pinched between the third roller 48 and the fourth roller 49 and a location at which the medium S is pinched between the first feeding roller 57 and the second feeding roller 58. Likewise, the second curve 39 corresponds to a portion of the lower feeding route 37 between a location where the medium S is pinched between the separate roller 54 and the retard roller 55 and a location where the medium S is pinched between the first feeding roller 57 and the second feeding roller 58.

The printing device 11 may further include a first sensor 61 and a second sensor 62 each of which detects a medium S. Each of the first sensor 61 and the second sensor 62 may be an optical sensor having a combination of a light emitting element and a light receiving element or a contact sensor having a lever to be brought into contact with the medium S. Each of the first sensor 61 and the second sensor 62 enters an ON state when detecting the medium S and enters an OFF state when not detecting the medium S.

The first sensor 61 detects the medium S positioned on the upper feeding route 36 between the roller pair 42 and the merging point G. In other words, the first sensor 61 detects the medium S transported along the upper feeding route 36. In this embodiment, the first sensor 61 is positioned on the upper feeding route 36. More specifically, the first sensor 61 is positioned on the upper feeding route 36 between the second roller pair 44 and the merging point G. Further, the first sensor 61 is positioned closer to the merging point G than the second roller pair 44. When the upstream side of the medium S enters the detection area of the first sensor 61 on the upper feeding route 36, the first sensor 61 switches from the OFF state to the ON state. When the downstream side of the medium S leaves the detection area of the first sensor 61 on the upper feeding route 36, the first sensor 61 switches from the ON state to the OFF state.

The second sensor 62 detects the medium S positioned on the lower feeding route 37 between the first feeding roller 57 and the third feeding roller 59. In other words, the second sensor 62 detects the medium S transported along the lower feeding route 37. In this embodiment, the second sensor 62 is positioned on the lower feeding route 37. More specifically, the second sensor 62 is positioned on the lower feeding route 37 between the first feeding roller 57 and the third feeding roller 59. Further, the second sensor 62 is positioned closer to the third feeding roller 59 than the first feeding roller 57. When the upstream side of the medium S enters the detection area of the second sensor 62 on the lower feeding route 37, the second sensor 62 switches from the OFF state to the ON state. When the downstream side of the medium S leaves the detection area of the second sensor 62 on the lower feeding route 37, the second sensor 62 switches from the ON state to the OFF state.

The printing device 11 may further include a guide route 63 along which the medium S to be fed to the print section 31 is returned to the lower feeding route 37. In this embodiment, the guide route 63 extends below the first feeding roller 57 from both the print section 31 and the support section 32 and is joined to the lower feeding route 37. The printing device 11 may guide the medium S to the guide route 63, for example, when performing the printing operations on both the surfaces, or a first surface and a second surface, of the medium S.

To perform the printing operation on the first and second surfaces of the medium S, at first, the print section 31 performs printing operation on the first surface of the medium S. Then, the third feeding roller 59 rotates in the reverse direction to feed the medium S along the guide route 63, thereby delivering the medium S to the lower feeding route 37. The medium S is turned over at the second curve 39, so that a second surface of the medium S faces the print section 31. Then, the print section 31 performs the printing operation on the second surface. In this way, the printing device 11 performs the printing operation on both the surfaces of the medium S.

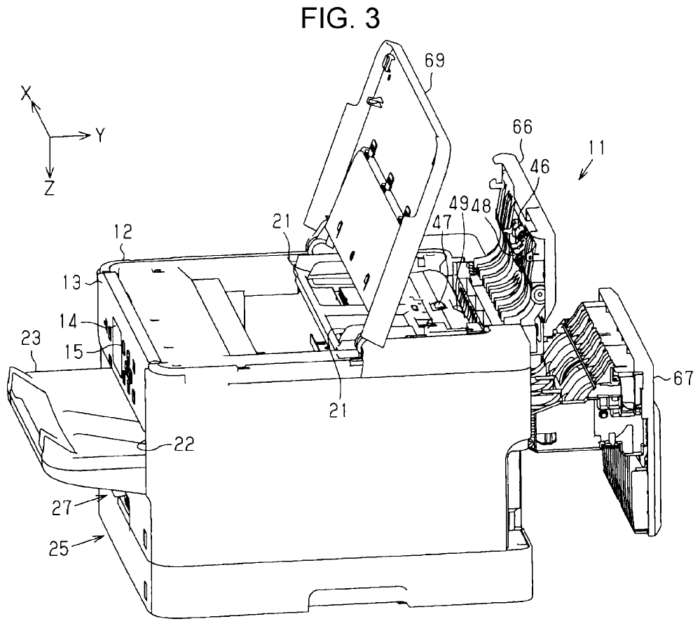

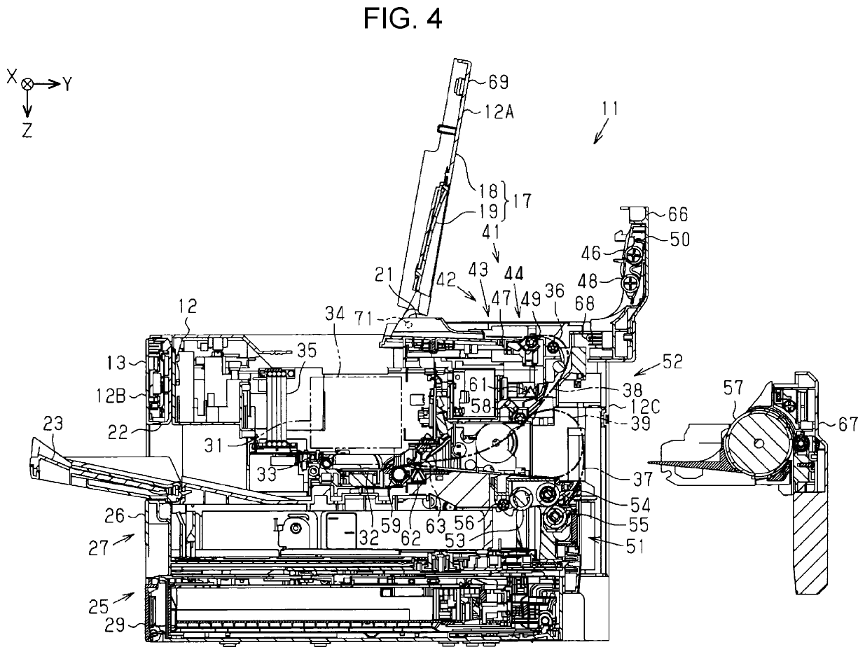

As illustrated in FIGS. 3 and 4, the main unit 12 includes a first cover 66 and a second cover 67. The first cover 66 allows the upper feeding route 36 to be exposed to the outside, whereas the second cover 67 allows the lower feeding route 37 to be exposed to the outside.

When transported along the upper feeding route 36 or the lower feeding route 37 in the printing device 11, the medium S may be stuck therein. If the medium S is stuck, it is necessary to remove it from the printing device 11. When the medium S is stuck on the upper feeding route 36, it is only necessary to operate the first cover 66 to expose the upper feeding route 36 to the outside. Performing this operation facilitates the removal of the medium S from the upper feeding route 36. When the medium S is stuck on the lower feeding route 37, it is only necessary to operate the second cover 67 to expose the lower feeding route 37 to the outside. Performing this operation facilitates the removal of the medium S from the lower feeding route 37. In short, providing a plurality of covers for the upper feeding route 36 and the lower feeding route 37 can facilitate the removal of the medium S from the main unit 12 if it is stuck in the main unit 12.

In this embodiment, as illustrated in FIG. 4, the first cover 66 is pivotable around a shaft 68 so that the upper feeding route 36 can be exposed to the outside. The first cover 66 thus can transit between a closed state and an open state, depending on the pivoting of the first cover 66 around the shaft 68. In FIGS. 1 and 2, the first cover 66 is in the closed state. In FIGS. 3 and 4, the first cover 66 is in the opened state. When the first cover 66 is opened, the upper feeding route 36 is exposed to the outside. When the first cover 66 is closed, the supply port 16 is defined by the first cover 66.

When the first cover 66 is in the closed state, the shaft 68 is positioned close to the rear surface 12C of the main unit 12. When being in the closed state, the first cover 66 forms a portion of the upper surface 12A of the main unit 12. Alternatively, the first cover 66 is detachable from the main unit 12. In this case, by detaching the first cover 66 from the main unit 12, the upper feeding route 36 may be exposed to the outside.

In this embodiment, the first cover 66 supports the first roller 46, the third roller 48, and the support section 50. When the first cover 66 is opened, the first roller 46 is displaced away from the second roller 47, and the third roller 48 is displaced away from the fourth roller 49. If the medium S is stuck in the first roller pair 43 or the second roller pair 44, it is only necessary to open the first cover 66 to displace both the first roller 46 and the third roller 48 away from the medium S. In this way, the user can remove the medium S easily from the upper feeding route 36.

In this embodiment, the second cover 67 is detachable from the main unit 12 so that the lower feeding route 37 can be exposed to the outside. In this embodiment, when the second cover 67 is detached, a portion of the upper feeding route 36 and the entire guide route 63 are exposed to the outside. The second cover 67 is detachably attached to the main unit 12. In FIGS. 1 and 2, the second cover 67 is attached to the main unit 12. In FIGS. 3 and 4, the second cover 67 is detached from the main unit 12. When being attached to the main unit 12, the second cover 67 forms a portion of the rear surface 12C of the main unit 12. When the second cover 67 is detached from the main unit 12, the lower feeding route 37 is exposed to the outside. Alternatively, the second cover 67 may be pivotable, similar to the first cover 66. In this case, by pivoting the second cover 67, the lower feeding route 37 may be exposed to the outside.

In this embodiment, the second cover 67 supports the first feeding roller 57. When the second cover 67 is detached from the main unit 12, the first feeding roller 57 is displaced away from the second feeding roller 58. If the medium S is stuck between the first feeding roller 57 and the second feeding roller 58, it is only necessary to detach the second cover 67 to displace the first feeding roller 57 away from the medium S. The medium S thereby can be removed easily from the lower feeding route 37. In this embodiment, by detaching the second cover 67, the medium S can be removed from the guide route 63.

In the printing device 11, the first sensor 61 detects the medium S present on the upper feeding route 36 between the roller pair 42 and the merging point G. Likewise, the second sensor 62 detects the medium S present on the lower feeding route 37 between the first feeding roller 57 and the third feeding roller 59. For example, if the first sensor 61 is kept in the ON state over a predetermined period, the medium S may be stuck at any point on the upper feeding route 36. If the second sensor 62 is kept in the ON state over a predetermined period, the medium S may be stuck at any point on the lower feeding route 37. In this way, the printing device 11 can determine where the medium S is stuck, based on the detection results of the first sensor 61 and the second sensor 62. After the determination, the printing device 11 may notify the user that the medium S has been stuck.

If the medium S is stuck in the main unit 12, the printing device 11 may notify the user to expose the upper feeding route 36, the lower feeding route 37, or both the upper feeding route 36 and the lower feeding route 37, based on the detection results of the first sensor 61 and the second sensor 62. This notification enables the user to realize which route should be exposed when the medium S is stuck. As a result, the user can remove the medium S promptly. In this case, the printing device 11 may make the notification through the display screen 14 or through an external terminal, such as a computer, electrically coupled to the printing device 11.

Instead of notifying the user to expose the upper feeding route 36, the printing device 11 may notify the user to open the first cover 66. Instead of notifying the user to expose the lower feeding route 37, the printing device 11 may notify the user to detach the second cover 67. Instead of notifying the user to expose both the upper feeding route 36 and the lower feeding route 37, the printing device 11 may notify the user to open both the first cover 66 and detaching the second cover 67.

If the medium S that has been stuck in the main unit 12 is detected by both the first sensor 61 and the second sensor 62, the printing device 11 may notify the user which of the lower feeding route 37 and both the upper feeding route 36 and the lower feeding route 37 should be exposed, based on the length of the medium S. In this case, the printing device 11 may acquire the size of the medium S from image data used to perform the printing operation on the medium S or from data that has been input by the user.

When the medium S that has been stuck in the main unit 12 is detected by both the first sensor 61 and the second sensor 62, the medium S may be present in both the upper feeding route 36 and the lower feeding route 37. In this case, if the medium S is considerably short in length, the medium S is less likely to be stuck in the roller pair 42. The user thus can remove the medium S from the main unit 12 by exposing the lower feeding route 37 alone. In other words, the user does not have to expose the upper feeding route 36. As a result, the user can remove the medium S promptly.

If the medium S that has been stuck in the main unit 12 is not detected by any of the first sensor 61 and the second sensor 62, the printing device 11 may notify the user which of the upper feeding route 36 and the lower feeding route 37 should be opened, based on the history of the detection result of the first sensor 61. Examples of the above case include: a case where the first sensor 61 does not enter the ON state within a predetermined period after the medium S has been inserted via the supply port 16; and a case where the second sensor 62 does not enter the ON state within a predetermined period after the first sensor 61 has switched from the ON state to the OFF state.

When the medium S that has been stuck in the main unit 12 is not detected by any of the first sensor 61 and the second sensor 62, the medium S may be present on the upper feeding route 36 in spacing between the supply port 16 and the detection area of the first sensor 61 or on the lower feeding route 37 between the first feeding roller 57 and the third feeding roller 59. In this case, the history of the detection result of the first sensor 61 which the printing device 11 refers to indicates that the first sensor 61 switches from the ON state to the OFF state or is kept in the OFF state. If the first sensor 61 switches from the ON state to the OFF state, the medium S may be stuck on the lower feeding route 37 between the first feeding roller 57 and the third feeding roller 59. Thus, by exposing the lower feeding route 37, the medium S can be removed. If the first sensor 61 is kept in the OFF state, the medium S may be stuck on the upper feeding route 36 in spacing between the supply port 16 and the detection area of the first sensor 61. Thus, by exposing the upper feeding route 36, the medium S can be removed. Referring to the history in this manner can facilitate the removal of the medium S promptly.

The main unit 12 may include a third cover 69 above the print section 31. The third cover 69 allows the interior of the main unit 12 to be exposed to the outside. In this embodiment, the third cover 69 is pivotable around a shaft 71 so that the interior of the main unit 12 is exposed to the outside. In this embodiment, the third cover 69 forms respective portions of the upper surface 12A and the placement surface 17 of the main unit 12.

In this embodiment, the third cover 69 transits between a closed state and an open state, depending on the pivoting of the third cover 69 around the shaft 71. In FIGS. 1 and 2, the third cover 69 is in the closed state. In FIGS. 3 and 4, the third cover 69 is in the opened state. When the third cover 69 is opened, the interior of the main unit 12 is exposed to the outside.

When the third cover 69 is in the closed state, the shaft 71 is positioned close to the rear surface 12C of the main unit 12. Alternatively, the third cover 69 is detachable from the main unit 12, similar to the second cover 67. In this case, the third cover 69 may be detached from the main unit 12 so that the interior of the main unit 12 is exposed to the outside. If the medium S is stuck in the ejection port 22 during or after the printing operation, the third cover 69 can be operated to remove the medium S from the main unit 12.

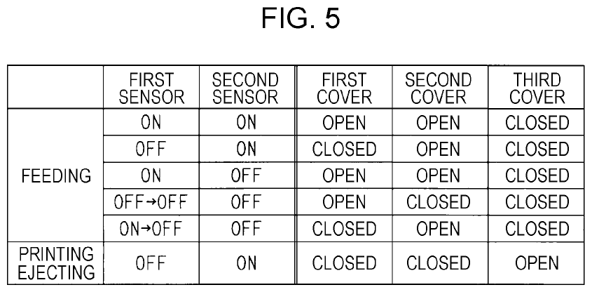

Next, a description will be given of an operational instruction that the printing device 11 gives the user when a medium S is stuck in the main unit 12. As illustrated in FIG. 5, when a medium S that has been inserted via the supply port 16 is stuck in the main unit 12, the printing device 11 notifies the user of which cover should be operated in order to remove the medium S, based on the detection results of the first sensor 61 and the second sensor 62.

States that cause the printing device 11 to determine that a medium S inserted via the supply port 16 is stuck in the main unit 12 are as follows: the first sensor 61 does not enter the ON state within a predetermined period after the insertion of the medium S; the first sensor 61 does not switch from the ON state to the OFF state within a predetermined period after having entered the ON state; the second sensor 62 does not enter the ON state within a predetermined period after the first sensor 61 has switched to the OFF state; and the second sensor 62 does not switch from the ON state to OFF state within a predetermined period after having entered the ON state.

When the medium S inserted via the supply port 16 is stuck in the main unit 12, if both the first sensor 61 and the second sensor 62 are in the ON state, the printing device 11 notifies the user to operate both the first cover 66 and the second cover 67. In this case, the medium S may be pinched in the roller pair 42 and between the first feeding roller 57 and the second feeding roller 58. For this reason, the printing device 11 notifies the user to expose both the upper feeding route 36 and the lower feeding route 37. For example, if the medium S has a length shorter than a predetermined length, the printing device 11 may notify the user to operate only the second cover 67, as described above. As an example, this predetermined length may be set to the distance between the second roller pair 44 on the upper feeding route 36 and the detection area of the second sensor 62 on the lower feeding route 37.

When the medium S inserted via the supply port 16 is stuck in the main unit 12, if the first sensor 61 is the OFF state but the second sensor 62 is in the ON state, the printing device 11 notifies the user to operate the second cover 67. In this case, by exposing the lower feeding route 37 alone, the medium S can be removed easily. This is because the medium S is not pinched in the roller pair 42.

When the medium S inserted via the supply port 16 is stuck in the main unit 12, if the first sensor 61 is in the ON state but the second sensor 62 is in the OFF state, the printing device 11 notifies the user to operate both the first cover 66 and the second cover 67. In this case, the medium S may be pinched in the roller pair 42 and between the first feeding roller 57 and the second feeding roller 58. For this reason, the printing device 11 notifies the user to expose both the upper feeding route 36 and the lower feeding route 37.

When the medium S inserted via the supply port 16 is stuck in the main unit 12, if both the first sensor 61 and the second sensor 62 are in the OFF state, the printing device 11 refers to the history of the detection result of the first sensor 61. If the first sensor 61 is kept in the OFF state over a predetermined period, the printing device 11 notifies the user to operate the first cover 66. In this case, since the medium S does not reach the detection area of the first sensor 61, the medium S may be present on the upper feeding route 36 in spacing between the supply port 16 and the detection area of the first sensor 61. For this reason, the printing device 11 notifies the user to expose the upper feeding route 36.

If the history of the detection result of the first sensor 61 indicates that the first sensor 61 switches from the ON state to the OFF state, the printing device 11 notifies the user to operate the second cover 67. In this case, since the medium S has already passed through the detection area of the first sensor 61, the medium S may be present in spacing between the detection area of the first sensor 61 on the upper feeding route 36 and the detection area of the second sensor 62 on the lower feeding route 37. For this reason, the printing device 11 notifies the user to expose the lower feeding route 37.

When the medium S is stuck in the main unit 12 during the printing or the ejecting operation, if the first sensor 61 is in the OFF state but the second sensor 62 is in the ON state, the printing device 11 notifies the user to operate the third cover 69. In this case, the medium S may be present close to the print section 31. For this reason, the printing device 11 notifies the user to expose the interior of the main unit 12.

When the medium S is stuck in the main unit 12 during the printing or ejecting operation, if both the first sensor 61 and the second sensor 62 are in the ON state, the printing device 11 notifies the user to operate both the first cover 66 and the second cover 67.

If the second sensor 62 does not enter the ON state within a predetermined period after a medium S has been transported from the medium storage section 26, the printing device 11 determines that the medium S is stuck in the main unit 12. Then, if the second sensor 62 does not switch from the ON state to the OFF state within a predetermined period, the printing device 11 also determines that the medium S is stuck. When the medium S transported from the medium storage section 26 is stuck in the main unit 12, the printing device 11 notifies the user to operate the second cover 67.

Next, functions and effects of the foregoing embodiment will be described below.

(1) In a printing device 11, a main unit 12 includes a first cover 66 and a second cover 67. The first cover 66 allows an upper feeding route 36 to be exposed, whereas the second cover 67 allows a lower feeding route 37 to be exposed. This configuration facilitates removal of the medium S through an operation of the first cover 66 if a medium S is stuck on the upper feeding route 36. Likewise, the configuration facilitates removal of the medium S through an operation of the second cover 67 if a medium S is stuck on the lower feeding route 37. Providing a plurality of covers for the upper feeding route 36 and the lower feeding route 37 in this manner can facilitate the removal of the medium S stuck on the upper feeding route 36 or the lower feeding route 37.

(2) The first cover 66 may be pivotable around a shaft 68 so that the upper feeding route 36 is exposed. The second cover 67 may be detachable from the main unit 12 so that the lower feeding route 37 is exposed. This configuration facilitates exposure of the upper feeding route 36 and the lower feeding route 37. In short, a configuration in which one of the first cover 66 and the second cover 67 is pivotable around a shaft and the other is detachable from the main unit 12 can facilitate opening of the first cover or the second cover to remove the medium S from the main unit 12 if a medium S is stuck in the main unit 12.

(3) The printing device 11 may include a first sensor 61 and a second sensor 62. The first sensor 61 may detect a medium S present on the upper feeding route 36 between a merging point G and a roller pair 42; the upper feeding route 36 is joined to the lower feeding route 37 at the merging point G. The second sensor 62 may detect a medium S present on the lower feeding route 37 between a first feeding roller 57 and a third feeding roller 59. With this configuration, the first sensor 61 can detect the medium S present on the upper feeding route 36 between the merging point G, at which the upper feeding route 36 is joined to the lower feeding route 37, and the roller pair 42. Likewise, the second sensor 62 can detect the medium S present on the lower feeding route 37 between the first feeding roller 57 and the third feeding roller 59. For example, if the first sensor 61 continues to detect a medium S over a predetermined period, the printing device 11 may determine that the medium S is stuck on the upper feeding route 36. If the second sensor 62 continues to detect a medium S over a predetermined period, the printing device 11 may determine that the medium S is stuck on the lower feeding route 37. In short, the configuration can locate a medium S stuck in the main unit 12, based on detection results of the first sensor 61 and the second sensor 62.

(4) When the medium S is stuck in the main unit 12, the printing device 11 may make a notification to expose the upper feeding route 36, the lower feeding route 37, or both the upper feeding route 36 and the lower feeding route 37, based on the detection results of the first sensor 61 and the second sensor 62. This configuration enables a user to know which route should be exposed if a medium S is stuck in the main unit 12. As a result, the user can remove the medium S promptly.

(5) When the medium S that has been stuck in the main unit 12 is detected by both the first sensor 61 and the second sensor 62, the printing device 11 may make a notification to expose the lower feeding route 37 or both the upper feeding route 36 and the lower feeding route 37, based on a length of the medium S. If the medium S stuck in the main unit 12 is detected by both the first sensor 61 and the second sensor 62, the medium S may be present on both the upper feeding route 36 and the lower feeding route 37. However, if the medium S is considerably short in length, the medium S is less likely to be pinched in the roller pair 42. In this case, by exposing the lower feeding route 37 alone, the medium S can be removed easily. Thus, the upper feeding route 36 does not have to be exposed. As a result, the medium S can be removed promptly.

(6) When the medium S that has been stuck in the main unit 12 is not detected by any of the first sensor 61 and the second sensor 62, the printing device 11 may make a notification to expose the upper feeding route 36 or the lower feeding route 37, based on a history of a detection result of the first sensor 61. If the medium S that has been stuck in the main unit 12 is not detected by any of the first sensor 61 and the second sensor 62, the medium S may be present on the upper feeding route 36 in spacing between a supply port 16 and a detection area of the first sensor 61 or on the lower feeding route 37 between the first feeding roller 57 and the third feeding roller 59. In this case, the history of the detection result of the first sensor 61 which the printing device 11 has referred to indicates a case where the first sensor 61 detected the medium S but presently fails to detect the medium S or a case where the first sensor 61 continues not to detect the medium S. In the former case, the medium S may be present on the lower feeding route 37 between the first feeding roller 57 and the third feeding roller 59. Thus, by exposing the lower feeding route 37, the medium S can be removed easily. In the latter case, the medium S may be present on the upper feeding route 36 in spacing between the supply port 16 and the detection area of the first sensor 61. Thus, by exposing the upper feeding route 36, the medium S can be removed easily. As a result, the medium S can be removed promptly.

(7) The main unit 12 may further include a third cover 69 above the print section 31. The third cover 69 may allow an interior of the main unit 12 to be exposed. This configuration enables the medium S to be removed from the main unit 12 through an operation of the third cover 69 if a medium S is stuck in the main unit 12 during or after a printing operation.

The foregoing embodiment may undergo some modifications as will be described below. It should be noted that such modifications and the foregoing embodiment may be carried out together unless they are technically inconsistent with one another. Instead of being pivotable around a shaft 68, the first cover 66 may be detachable from the ejection port 22.

Instead of being detachable from the ejection port 22, the second cover 67 may be pivotable around the shaft. Instead of a paper sheet, each medium S may be a cloth sheet or a plastic film.

Instead of liquid, the printing device 11 may use fine particles, such as toner particles, to perform a printing operation. Liquid discharged from a print section 31 in the printing device 11 is not limited to ink. Alternatively, the liquid may be a liquid body in which particles of a functional material are dispersed or mixed in liquid, for example. As an example, the print section 31 may discharge a liquid body in which a material, such as an electrode material or a color material, to be used to manufacture liquid crystal displays, electro luminescence displays, or surface luminous displays, and other displays is dispersed or dissolved.

A description will be given below of technical ideas, functions, and effects that can be derived from the foregoing embodiment and modifications.

A printing device includes a print section that performs a printing operation on a medium. A main unit accommodates the print section and has, on an upper surface, a supply port via which the medium is to be inserted. The medium inserted via the supply port is to be guided to the print section along an upper feeding route. The upper feeding route has, at a midway point, a first curve at which the medium is to be turned around. A medium storage section that accommodates a medium is positioned below the main unit. The medium accommodated in the medium storage section is to be guided to the print section along a lower feeding route. The lower feeding route has, at a midway point, a second curve at which the medium is to be turned around. The main unit includes a first cover and a second cover. The first cover allows the upper feeding route to be exposed, and the second cover allows the lower feeding route to be exposed.

The above configuration facilitates removal of the medium through an operation of the first cover if a medium is stuck on the upper feeding route. Likewise, the configuration facilitates removal of the medium through an operation of the second cover if a medium is stuck on the lower feeding route. Providing a plurality of covers for the upper feeding route and the lower feeding route in this manner can facilitate the removal of the medium stuck on the upper feeding route or the lower feeding route.

In the above printing device, the first cover may be pivotable around a shaft so that the upper feeding route is exposed, and the second cover may be detachable from the main unit so that the lower feeding route is exposed.

The above configuration facilitates exposure of the upper feeding route and the lower feeding route. In short, a configuration in which one of the first cover and the second cover is pivotable around a shaft and the other is detachable from the main unit 12 can facilitate opening of the first cover or the second cover to remove the medium from the main unit if a medium is stuck in the main unit.

The above printing device may further include a roller pair positioned on the upper feeding route between the supply port and the first curve. The roller pair may feed the medium along the upper feeding route. The upper feeding route may be joined to the lower feeding route. A first feeding roller may have an outer circumferential surface conforming to the second curve. A second feeding roller and the first feeding roller may pinch the medium transported along the upper feeding route and the lower feeding route. A third feeding roller may be positioned on the lower feeding route between the first feeding roller and the print section. A first sensor may detect a medium on the upper feeding route between the roller pair and a merging point at which the upper feeding route is joined to the lower feeding route. A second sensor may detect a medium on the lower feeding route between the first feeding roller and the third feeding roller.

With this configuration, the first sensor can detect the medium present on the upper feeding route between the merging point, at which the upper feeding route is joined to the lower feeding route, and the roller pair. The second sensor can detect the medium present on the lower feeding route between the first feeding roller and the third feeding roller. For example, if the first sensor continues to detect a medium over a predetermined period, the printing device may determine that the medium is stuck on the upper feeding route. If the second sensor continues to detect a medium over a predetermined period, the printing device may determine that the medium is stuck on the lower feeding route. In short, the configuration can locate a medium stuck in the main unit, based on detection results of the first sensor and the second sensor.

In the printing device, when the medium is stuck in the main unit, the printing device may make a notification to expose the upper feeding route, the lower feeding route, or both the upper feeding route and the lower feeding route, based on the detection results of the first sensor and the second sensor.

This configuration enables a user to know which route should be exposed if a medium is stuck in the main unit 12. As a result, the user can remove the medium promptly. When a medium that has been stuck in a main unit is detected by both the first sensor and the second sensor, the printing device may make a notification to expose the lower feeding route or both the upper feeding route and the lower feeding route, based on a length of the medium.

If the medium that has been stuck in the main unit is detected by both the first sensor and the second sensor, the medium may be present on both the upper feeding route and the lower feeding route. However, if the medium is considerably short in length, the medium is less likely to be pinched in the roller pair. In this case, by exposing the lower feeding route alone, the medium can be removed easily. Thus, the upper feeding route does not have to be opened. As a result, the medium can be removed promptly.

When the medium that has been stuck in the main unit is not detected by any of the first sensor and the second sensor, the printing device may make a notification to expose the upper feeding route or the lower feeding route, based on a history of a detection result of the first sensor.

If the medium stuck in the main unit is not detected by any of the first sensor and the second sensor, the medium may be present on the upper feeding route in spacing between the supply port and a detection area of the first sensor or on the lower feeding route between the first feeding roller and the third feeding roller. In this case, the history of the detection result of the first sensor which the printing device has referred to indicates a case where the first sensor detected the medium S but presently fails to detect the medium or a case where the first sensor continues not to detect the medium. In the former case, the medium may be present on the lower feeding route between the first feeding roller and the third feeding roller. Thus, by exposing the lower feeding route, the medium can be removed easily. In the latter case, the medium may be present on the upper feeding route in spacing between the supply port and the detection area of the first sensor. Thus, by exposing the upper feeding route, the medium can be removed easily. As a result, the medium S can be removed promptly.

In the above printing device, the main unit may further include a third cover above the print section. The third cover may allow an interior of the main unit to be exposed.

This configuration enables the medium S to be removed from the main unit through an operation of the third cover if a medium is stuck in the main unit during or after a printing operation.

What is claimed is:

1. A printing device comprising:
a print section that performs a printing operation on a medium;
a main unit that accommodates the print section, the main unit having, on an upper surface, a supply port via which the medium is to be inserted;
an upper feeding route along which the medium inserted via the supply port is to be guided to the print section, the upper feeding route having, at a midway point, a first curve at which the medium is to be turned around;
a medium storage section that accommodates a medium, the medium storage section being positioned below the main unit; and
a lower feeding route along which the medium accommodated in the medium storage section is to be guided to the print section, the lower feeding route having, at a midway point, a second curve at which the medium is to be turned around,
the main unit including a first cover and a second cover, the first cover allowing the upper feeding route to be exposed, the second cover allowing the lower feeding route to be exposed.

2. The printing device according to claim 1, wherein
the first cover is pivotable around a shaft so that the upper feeding route is exposed, and
the second cover is detachable from the main unit so that the lower feeding route is exposed.

3. The printing device according to claim 1, further comprising:
a roller pair that feeds the medium along the upper feeding route, the roller pair being positioned on the upper feeding route between the supply port and the first curve, the upper feeding route being joined to the lower feeding route;
a first feeding roller that has an outer circumferential surface conforming to the second curve;
a second feeding roller that pinches the medium transported along the upper feeding route and the lower feeding route in conjunction with the first feeding roller;
a third feeding roller positioned on the lower feeding route between the first feeding roller and the print section;
a first sensor that detects a medium on the upper feeding route between the roller pair and a merging point at which the upper feeding route is joined to the lower feeding route; and
a second sensor that detects a medium on the lower feeding route between the first feeding roller and the third feeding roller.

4. The printing device according to claim 3, wherein
when a medium is stuck in the main unit, the printing device makes a notification to expose the upper feeding route, the lower feeding route, or both the upper feeding route and the lower feeding route, based on detection results of the first sensor and the second sensor.

5. The printing device according to claim 3, wherein
when a medium that has been stuck in the main unit is detected by both the first sensor and the second sensor, the printing device makes a notification to expose the lower feeding route or both the upper feeding route and the lower feeding route, based on a length of the stuck medium.

6. The printing device according to claim 3, wherein
when a medium that has been stuck in the main unit is not detected by any of the first sensor and the second sensor, the printing device makes a notification to expose the upper feeding route or the lower feeding route, based on a history of a detection result of the first sensor.

7. The printing device according to claim 1, wherein
the main unit further includes a third cover above the print section, the third cover allowing an interior of the main unit to be exposed.
